(19) United States
(12) Patent Application Publication
(10) Pub. No.: US 2013/0027367 A1
(43) Pub. Date: Jan. 31, 2013

(54) LIQUID CRYSTAL DISPLAY DEVICE

(71) Applicants: Kaori Saitoh, Osaka-shi (JP); Keisuke Yoshida, Osaka-shi (JP); Yasutoshi Tasaka, Osaka-shi (JP); Yoshimizu Moriya, Osaka-shi (JP); Keiichi Ina, Osaka-shi (JP)

(72) Inventors: Kaori Saitoh, Osaka-shi (JP); Keisuke Yoshida, Osaka-shi (JP); Yasutoshi Tasaka, Osaka-shi (JP); Yoshimizu Moriya, Osaka-shi (JP); Keiichi Ina, Osaka-shi (JP)

(21) Appl. No.: 13/638,958

(22) PCT Filed: Mar. 22, 2011
(86) PCT No.: PCT/JP2011/056823

§ 371 Date: Oct. 2, 2012

(30) Foreign Application Priority Data
Apr. 16, 2010 (JP) 2010-095288

(51) Int. Cl. G09G 3/36; G06F 3/038

(52) U.S. Cl. 345/204; 345/87

(57) ABSTRACT

In a picture element (100), transmissive electrodes (130, 140) are connected to each other, and reflective electrodes (110, 120) adjacent to the transmissive electrodes are connected to the transmissive electrodes (130, 140), respectively. However, the reflective electrodes (110, 120) are not connected to each other. Alignment controlling structures (111, 121, 131, 141) are provided in regions which correspond to central parts of the respective electrodes, and an alignment controlling structure (151) is provided between the reflective electrodes (110, 120) which are not connected to each other. An alignment of liquid crystals is forcibly made stable in the vicinity of the reflective electrodes by providing the alignment controlling structure (151). It is thus possible to achieve a transflective liquid crystal display device having an excellent display characteristic, such as less roughness and fewer residual images.

### TECHNICAL FIELD

The present invention relates to liquid crystal display devices and, in particular, to a transflective liquid crystal display device including a reflective region where a display is carried out in a reflective mode and a transmissive region where a display is carried out in a transmissive mode.

### BACKGROUND ART

Recently, liquid crystal display devices are widely used as display devices of personal computers or portable information terminals. The apparatus such as personal computers or portable information terminals are often used not only indoors but also outdoors. Accordingly, display devices having a high level of visibility both in the indoors and outdoors are desired. In the outdoors, a user often uses such a display device while doing something else. A display device is thus required which has a high level of visibility when seen from every direction.

Patent Literature 1 discloses a transflective liquid crystal display device which meets the above-mentioned requirement and has an improved viewing angle characteristic. FIG. 5 illustrates the transflective liquid crystal display device disclosed in Patent Literature 1. (a) of FIG. 5 is a plan view illustrating a configuration of electrodes in one picture element region of the transflective liquid crystal display device, and (b) of FIG. 5 is a cross sectional view taken along the line 1B-1B′ in (a) of FIG. 5.

In (a) of FIG. 5, a reference numeral 500 denotes one picture element of the transflective liquid crystal display device. The one picture element 500 includes two reflective regions R and one transmissive region T which is sandwiched by the two reflective regions R. Note that a picture element is a minimum unit of display, and in accordance with a general color liquid crystal display device, three picture elements which correspond to respective three colors of R, G, and B constitute one pixel. A picture element is also referred to as a sub pixel.

The reflective regions R includes three reflective electrodes 511, 512, and 513 which are (i) circular and (ii) arranged in a lateral direction (see above the transmissive region T in (a) of FIG. 5) and three reflective electrodes 531, 532, and 533 which are (i) circular and (ii) arranged in a lateral direction (see below the transmissive region T in (a) of FIG. 5). The transmissive region T includes three transmissive electrodes 521, 522, and 523 which are (i) circular and (ii) arranged in a lateral direction. Any two adjacent ones of the electrodes are connected to each other via a bridge electrode 510 having a narrow width (in FIG. 5, the reference numeral 510 is given to only one bridge electrode in order to prevent the figure from being complicated). Accordingly, in a case where a driving voltage is being applied, the same driving voltage is applied to all of the reflective electrodes 511, 512, and 513, and the transmissive electrodes 521, 522, and 523, and the reflective electrodes 531, 532, and 533.

As is illustrated in (b) of FIG. 5, the reflective electrodes 511, 512, and 513, and the transmissive electrodes 521, 522, and 523, and the reflective electrodes 531, 532, and 533 (i) are provided on an active matrix substrate 541 on which active elements for driving the electrodes are formed, and (ii) face a counter electrode 543 provided on a color filter substrate 542 on which color filters are formed. Further, liquid crystals 550 having negative dielectric constant anisotropy are sealed between the active matrix substrate 541 and the counter substrate 542.

In the example illustrated in FIG. 5, protrusions 544 made from a transparent dielectric material are formed in regions, on the color filter substrate 542, which correspond to the reflective regions R. The protrusions 544 serve to make retardation caused by the liquid crystals 550 substantially equivalent in the transmissive region T and the reflective regions R. Note, however, that the detailed description of the protrusions 544 will be omitted here.

While a driving voltage is being applied to such a transflective liquid crystal display device, an electric field in an oblique direction is generated on the periphery of each of circular electrodes, which constitute one picture element 500. This causes a plurality of liquid crystal domains to be formed along the electric field in the oblique direction. In each of the plurality of liquid crystal domains, the liquid crystals are tilted and oriented radially. As the result, it is possible to provide a transflective liquid crystal display device having an improved viewing angle characteristic.

Alignment controlling structures which are substantially circular (not illustrated in FIG. 5) can be provided in regions, on the color filter substrate, which face the respective central parts of the circular reflective electrodes 511, 512, and 513, the circular transmissive electrodes 521, 522, and 523, and the circular reflective electrodes 531, 532, and 533. As the alignment controlling structure, a variety of structures, typically, a protrusion made from a transparent dielectric material or other materials, can be employed.

According to the technology described in Patent Literature 1, a liquid crystal display device can be attained, which includes a transmissive region T and reflective regions R, and a plurality of liquid crystal domains in each of which liquid crystals are tilted and oriented radially. It is therefore possible to achieve a transflective liquid crystal display device which (i) is usable both in the indoors and the outdoors and (ii) has an excellent viewing angle characteristic.

### CITATION LIST

### Patent Literature

Patent Literature 1

Japanese Patent Application Publication Tokukai No. 2005-250431 A (Publication Date: Sep. 15, 2005)

### SUMMARY OF INVENTION

### Technical Problem

According to the technology described in Patent Literature 1, a transflective liquid crystal display device having an improved viewing angle characteristic can be attained. However, there is a problem that orientation state of the liquid crystals in the reflective region R is not always stable, resulting in failing to obtain a transflective liquid crystal display device having an intended characteristic.

FIG. 6 illustrates why an orientation state of liquid crystals in reflective regions of a conventional transflective liquid crystal display device become unstable, with reference to a solution attained by the inventors of the present invention.

In FIG. 6, a reference numeral 600 denotes a single picture element region. The single picture element region 600 is configured to include (i) two reflective electrodes 610 and 620, and (ii) two transmissive electrodes 630 and 640. Further, two adjacent ones of the electrodes are connected to each other via respective bridge electrodes 651, 652, 653, and 654. In the example of FIG. 6, alignment controlling structures are further formed in regions, on the color filter substrate, which face the respective central parts of the electrodes.

Namely, an alignment controlling structure 611 is provided so as to face the central part of the reflective electrode 610, an alignment controlling structure 621 is provided so as to face the central part of the reflective electrode 620, an alignment controlling structure 631 is provided so as to face the central part of the transmissive electrode 630, and an alignment controlling structure 641 is provided so as to face the central part of the transmissive electrode 640. As the alignment controlling structure, a variety of structures, typically, a protrusion made from a transparent dielectric material or other materials, can be employed.

While a voltage is being applied to the bridge electrodes 651, 652, 653, and 654, an oblique electric field is generated on the periphery of the bridge electrodes. This contributes to the orientation of liquid crystal molecules in an oblique direction. Note, however, that the reflective electrodes 610 and 620 are usually provided with small concavities and convexities for improvement in the reflection characteristics. This may cause the oblique electric field to compete with the concavities and convexities of the reflective electrodes, in the bridge electrode 651 between the reflective electrodes 610 and 620. This may cause (i) the orientation state of the liquid crystal molecules to be affected depending on, for example, how the concavities and convexities are formed and ultimately (ii) the orientation state to be unstable. In contrast, the transmissive electrodes 630 and 640 have respective flat surfaces facing the liquid crystals, and there is nothing which affects the transmissive electrodes 630 and 640, except for the central alignment controlling structures 631 and 641 and the bridge electrode 653. Accordingly, a stable orientation of the liquid crystal molecules can be achieved.

The present invention has been accomplished in view of the problem, and an object of the present invention is to provide a transflective liquid crystal display device which can achieve a stable orientation state of the liquid crystal molecules even in a reflective region R.

### Solution to Problem

In order to attain the above object, a transflective liquid crystal display device in accordance with the present invention is a transflective liquid crystal display device including: a first substrate on which a plurality of picture element electrodes and driving elements for selectively driving the picture element electrodes are provided; and a second substrate on which color filters are formed; and liquid crystals sealed between the first substrate and the second substrate, each of the plurality of picture element electrodes being constituted by (i) at least one transmissive electrode, (ii) at least one pair of two reflective electrodes which are adjacent to each other leftward and rightward or upward and downward, and (iii) bridge electrodes via each of which two adjacent ones of the at least one pair of reflective electrodes and the at least one transmissive electrode are connected to each other, the at least one pair of two reflective electrodes which are adjacent to each other being not connected to each other via the bridge electrode, alignment controlling structures for controlling alignment of the liquid crystals being provided in regions, on a second substrate side, which face respective central parts of the at least one pair of reflective electrodes and the at least one transmissive electrode, an alignment controlling structure(s) for controlling alignment of the liquid crystals being further provided in a region, on the second substrate side, which region faces a region, where no bridge electrode is provided, between the at least one pair of two reflective electrodes which are adjacent to each other.

According to the configuration, it is possible to provide a transflective liquid crystal display device which has (i) a stable orientation state of liquid crystals, and (ii) an excellent display characteristic, such as less roughness and fewer residual images. According to the transflective liquid crystal display device of the present invention, one picture element includes (i) at least one transmissive electrode, and (ii) at least one pair of reflective electrode which are adjacent to each other leftward and rightward or upward and downward. This leads to formation of a plurality of liquid crystal domains. This allows the transflective liquid crystal display device to further have an excellent viewing angle characteristic.

Other objects, features and advantages of the present invention are to be appreciated with reference to the description below. Further, advantageous effects of the present invention are to be appreciated with reference to the description on the basis of the attached drawings.

### Advantageous Effects of Invention

As has been described above, a transflective liquid crystal display device in accordance with the present invention includes: a first substrate on which a plurality of picture element electrodes and driving elements for selectively driving the picture element electrodes are provided; and a second substrate on which color filters are formed; and liquid crystals sealed between the first substrate and the second substrate, each of the plurality of picture element electrodes being constituted by (i) transmissive electrode, (ii) at least one pair of two reflective electrodes which are adjacent to each other leftward and rightward or upward and downward, and (iii) bridge electrodes via each of which two adjacent ones of the at least one pair of reflective electrodes and the at least one transmissive electrode are connected to each other, the at least one pair of two reflective electrodes which are adjacent to each other being not connected to each other via the bridge electrode, alignment controlling structures for controlling alignment of the liquid crystals being provided in regions, on a second substrate side, which face respective central parts of the at least one pair of reflective electrodes and the at least one transmissive electrode, an alignment controlling structure(s) for controlling alignment of the liquid crystals being further provided in a region, on the second substrate side, which region faces a region, where no bridge electrode is provided, between the at least one pair of two reflective electrodes which are adjacent to each other.

According to the present invention, it is possible to achieve a transflective liquid crystal display device having (i) an excellent viewing angle characteristic, and (ii) an excellent display characteristic, such as less roughness and fewer residual images.

### BRIEF DESCRIPTION OF DRAWINGS

FIG. 1

FIG. 1 illustrates a first example of the present invention.

FIG. 2

FIG. 2 illustrates variations of the first example of the present invention.

FIG. 3

FIG. 3 illustrates a second example of the present invention.

FIG. 4

FIG. 4 illustrates variations of the second example of the present invention.

FIG. 5

FIG. 5 illustrates a conventional technology.

FIG. 6

FIG. 6 is a diagram for explaining a problem in the conventional technology.

### DESCRIPTION OF EMBODIMENTS

The following description will discuss embodiments of the present invention with reference to the drawings in detail. Note that various limitations which is preferable to implement the present invention will be added to the following description, however, the technical scope of the present invention is not limited to the embodiments below and illustrations of the drawings.

### Embodiment 1

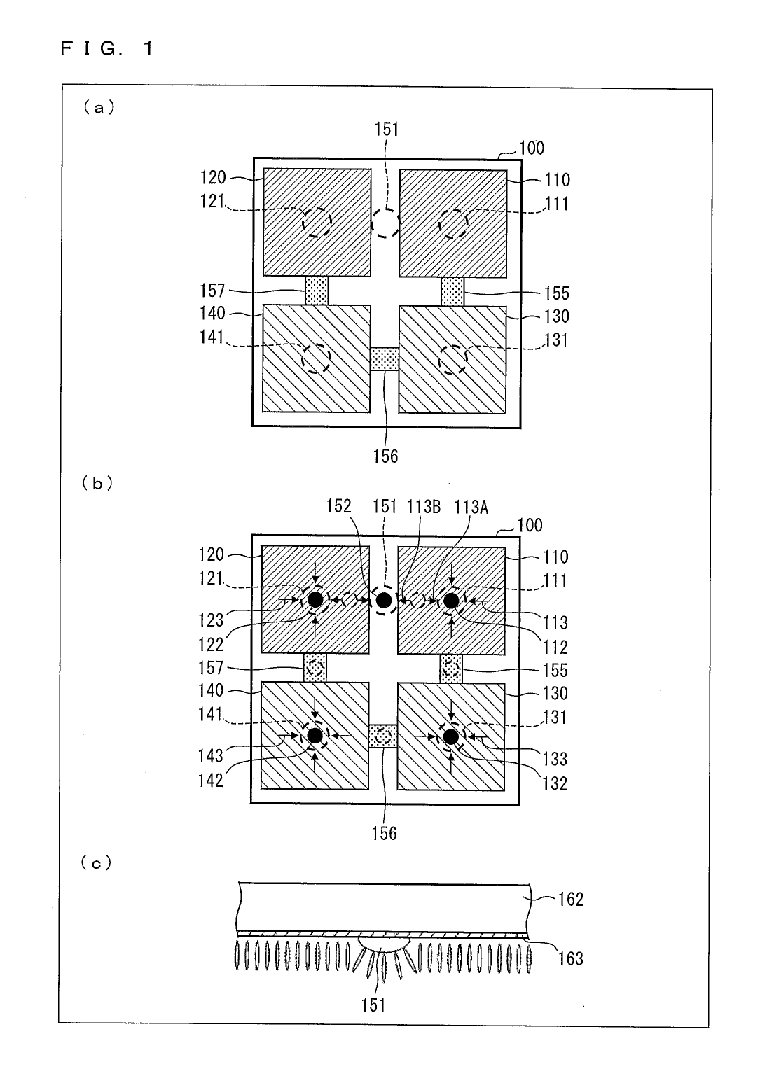

Embodiment 1 of the present invention will be described with reference to FIG. 1.

FIG. 1 illustrates a configuration of electrodes provided, on an active matrix substrate side, in one of picture element regions 100 (hereinafter, referred to merely as a picture element 100) constituting a transflective liquid crystal display device in accordance with the present invention. On an active matrix substrate, serving as a first substrate, driving elements such as TFTs are formed. The active matrix substrate is also referred to as a TFT substrate. A picture element is a minimum unit of a display. With regard to a general color liquid crystal display device, each pixel is constituted by three picture elements which correspond to respective three colors of R, G, and B. A picture element is also referred to as a sub pixel. On the active matrix substrate, a plurality of picture element electrodes are provided so that each picture element electrode is selectively driven by a corresponding active element (a driving element).

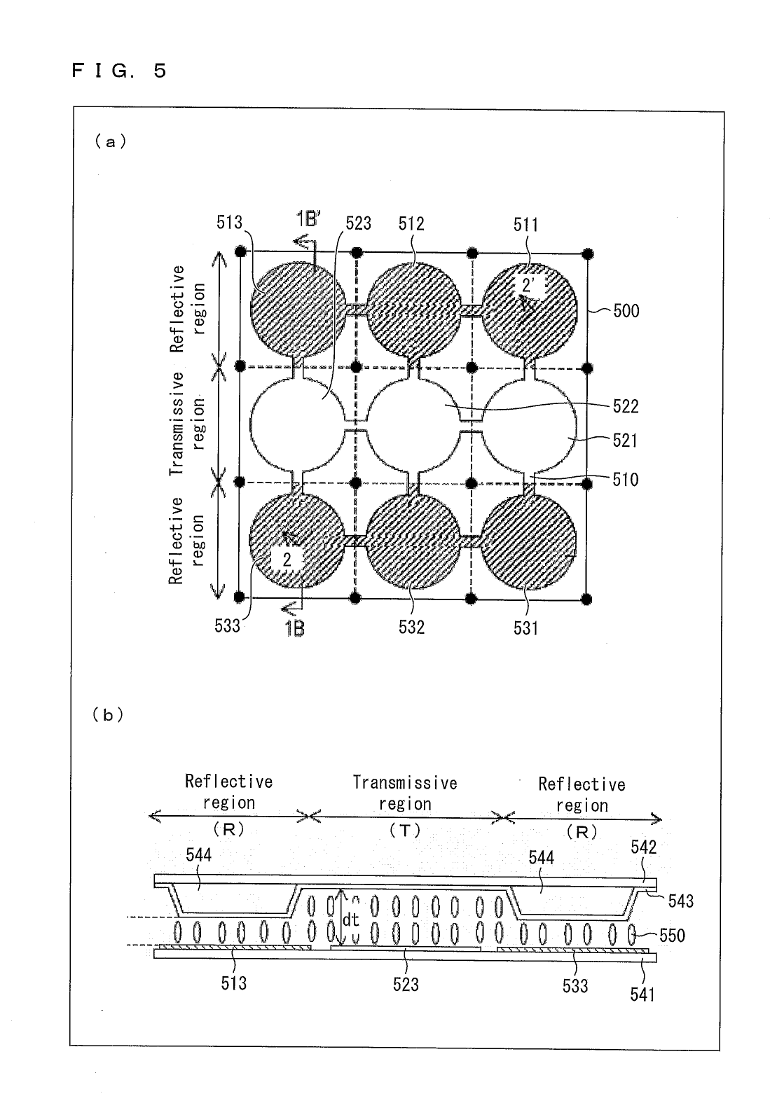

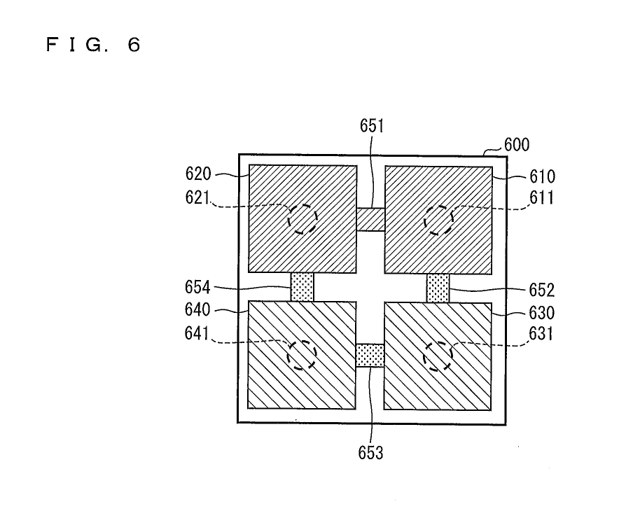

The present specification does not specifically describe a cross-section configuration of the transflective liquid crystal display device in accordance with the present invention. However, the transflective liquid crystal display device can have a cross-section configuration which is similar to that of the conventional technology illustrated in FIG. 5. Therefore, also in Embodiment 1, liquid crystals are sealed in a gap between (i) the picture element electrodes and (ii) a counter electrode provided on a color filter substrate (a second substrate) (not illustrated). (a) of FIG. 1 illustrates a state in which no driving voltage is applied across the picture element electrodes and the counter electrode, and (b) of FIG. 1 illustrates how liquid crystal molecules orient while a driving voltage is being applied across the picture element electrodes and the counter electrode. Further, (c) of FIG. 1 illustrates a typical alignment controlling structure.

In FIG. 1, the picture element 100 includes a plurality of electrodes on the active matrix substrate (the first substrate). Specifically, the picture element 100 includes two reflective electrodes 110 and 120, and two transmissive electrodes 130 and 140. An alignment controlling structure 111 for controlling the alignment of the liquid crystals is provided in a region, on a color filter substrate (the second substrate) side, which region faces a central part of the reflective electrode 110. An alignment controlling structure 121 for controlling the alignment of the liquid crystals is provided in a region, on the color filter substrate side, which region faces a central part of the reflective electrode 120. An alignment controlling structure 131 for controlling the alignment of the liquid crystals is provided in a region, on the color filter substrate side, which region faces a central part of the transmissive electrode 130. An alignment controlling structure 141 for controlling the alignment of the liquid crystals is provided in a region, on the color filter substrate side, which region faces a central part of the transmissive electrode 140 (the alignment controlling structure for controlling the alignment of the liquid crystals being hereafter referred to as just an alignment controlling structure).

The transmissive electrodes 130 and 140 are connected to each other via a bridge electrode 156. The transmissive electrode 130 and the reflective electrode 110 are connected to each other via a bridge 155. The transmissive electrode 140 and the reflective electrode 120 are connected to each other via a bridge electrode 157. Each bridge electrode can be the same conductor as a reflective electrode or a transmissive electrode, and can be formed simultaneously with forming of the reflective electrode or the transmissive electrode. One picture element electrode is constituted by the two reflective electrodes 110 and 120, the two transmissive electrodes 130 and 140, and the bridge electrodes 155, 156, and 157.

According to Embodiment 1 of the present invention, as illustrated in (a) of FIG. 1, no bridge electrode is provided for connecting the reflective electrode 110 to the reflective electrode 120. Instead, an alignment controlling structure 151 is provided in a region, on the color filter substrate side, which region faces a region between the reflective electrode 110 and the reflective electrode 120. A protrusion being (i) made from a transparent dielectric material and (ii) provided on the counter electrode 163 on the color filter substrate 162 as illustrated in (c) of FIG. 1 can be used as the alignment controlling structure 151. Note, however, that Embodiment 1 is not limited to this, and therefore any other conventionally known alignment controlling structure can be employed as the alignment controlling structure 151.

(b) of FIG. 1 shows a state obtained in a case where a driving voltage is being applied across the picture element 100 of (a) of FIG. 1. (b) of FIG. 1 simply illustrates how the alignment controlling structures operate under such a state. In (b) of FIG. 1, arrows 113, 113A, 113B, 123, 133, and 143 indicate orientation states of liquid crystal molecules. Note that not all the arrows have reference numerals so that the figure is prevented from being complicated too much. Also note that black circle sections with the reference numerals 112, 122, 132, and 142 denotes the centers of orientation axes of the respective liquid crystal molecules (hereinafter, referred to as an orientation axis center).

In regions in which the respective transmissive electrodes 130 and 140 are provided, liquid crystal molecules are oriented radially towards the orientation axis centers 132 and 142 located at the central parts of the respective transmissive electrodes 130 and 140 (see the arrows 133 and 143). In a region between the reflective electrode 110 and the reflective electrode 120, no bridge is provided, and the alignment controlling structure 151 is provided instead.

In a region where the reflective electrode 110 is provided, due to the alignment controlling structure 151 thus provided, some liquid crystal molecules are oriented in a direction towards an orientation axis center 112 (in a direction of the arrow 113A), whereas some liquid crystal molecules are oriented in a direction towards an orientation axis center 152 (in a direction of an arrow 113B). Note, however, that no unstable orientation state is caused. It would appear that this will be caused by providing the alignment controlling structure having a stronger capability of alignment controlling than that of the bridge. This is because the provision of the alignment controlling structure causes an orientation center to be forcibly generated.

The same applies to a region where the reflective electrode 120 is provided. Namely, some liquid crystal molecules are oriented in a direction towards an orientation axis center 122, whereas some liquid crystal molecules are oriented in a direction towards an orientation axis center 152. Note, however, that this is forcibly caused by the alignment controlling structure 151, and thus no unstable orientation state is caused. In the other parts of the reflective electrodes 110 and 120, liquid crystal molecules are oriented substantially radially towards the orientation axis centers 112 and 122 (see the arrows 113 and 123), respectively. This makes it possible to provide a transflective liquid crystal display device having (i) a stable alignment characteristic, and (ii) an excellent display quality, such as less roughness, and fewer residual images.

According to Embodiment 1, two reflective electrodes and two transmissive electrodes are provided, that is, are identical in number, and the transflective liquid crystal display device has a relatively high level of visibility in both indoor and outdoor environments. With regard to a transflective liquid crystal display device including relatively large-sized pixel electrodes, the transflective liquid crystal display device can attain a more stable alignment of liquid crystals, and an excellent display quality, such as less roughness and fewer residual images, in a case where two reflective electrodes and two transmissive electrodes are provided than in a case where one reflective electrode and one transmissive electrode are provided.

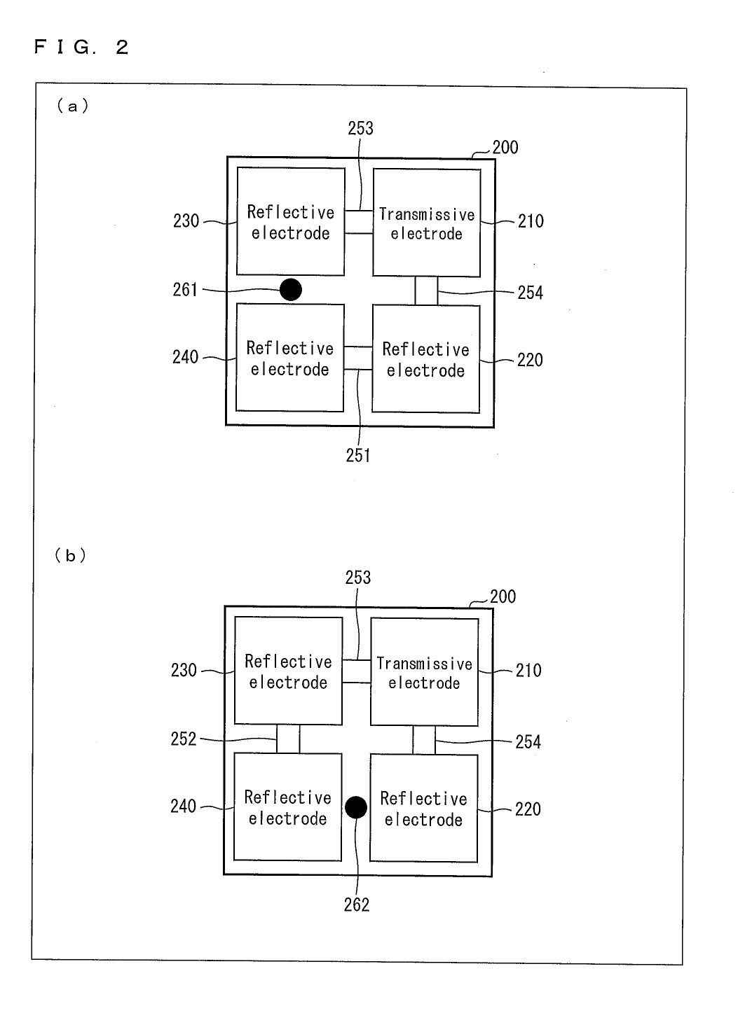

(a) and (b) of FIG. 2 illustrate modifications of the transflective liquid crystal display device, illustrated in FIG. 1, in accordance with the present invention. In the modifications illustrated in (a) and (b) of FIG. 2, the number of reflective electrodes is greater than that of transmissive electrodes. Such modifications are suitable for a liquid crystal display device which is often used outdoors.

(a) and (b) of FIG. 2 are identical to each other in that a picture element 200 includes one transmissive electrode 210 and three reflective electrodes 220, 230, and 240. However, they differ from each other in that their alignment controlling structures are provided in respective different regions which are located, on a color filter substrate side, between the two reflective electrodes.

According to the configuration illustrated in (a) of FIG. 2, a transmissive electrode 210 and a reflective electrode 220 are connected to each other via a bridge electrode 254, the transmissive electrode 210 and a reflective electrode 230 are connected to each other via a bridge electrode 253, and the reflective electrode 220 and a reflective electrode 240 are connected to each other via a bridge electrode 251. No bridge electrode is provided between the reflective electrode 230 and the reflective electrode 240. Instead, an alignment controlling structure 261 is provided in a region, on the color filter substrate side, which region faces a region between the reflective electrode 230 and the reflective electrode 240. The bridge electrode 251 is provided so that a driving voltage is supplied to the reflective electrode 240 via the bridge electrode 251. Since the alignment controlling structure is provided “in a region, on the color filter substrate side, which region faces a region between the reflective electrode 230 and the reflective electrode 240” as described above, it is possible to provide a transflective liquid crystal display device having a more stable alignment characteristic, as compared with a case where a bridge electrode is provided between any respective adjacent electrodes.

In (b) of FIG. 2, the reflective electrode 230 and the reflective electrode 240 are connected to each other via a bridge electrode 252. Instead, the reflective electrode 220 and the reflective electrode 240 are not connected to each other via a bridge electrode, and an alignment controlling structure 262 is provided in a region, on the color filter substrate side, which region faces a region between the reflective electrode 220 and the reflective electrode 240. Also in this case, as with the case of (a) of FIG. 2, it is possible to provide a transflective liquid crystal display device having a more stable alignment characteristic, as compared with a case where a bridge electrode is provided between any respective adjacent electrodes.

According to the modifications illustrated in (a) and (b) of FIG. 2, it is necessary that two reflective electrodes are connected to each other via a bridge electrode, in order that a driving voltage is applied to all of the electrodes in one picture element. According to a transflective display device including a plurality of reflective electrodes in one picture element, it is possible to attain, as a whole, more improvement in alignment characteristic of the display device, even in a case where part of the reflective electrodes are connected to each other via a bridge electrode(s), as compared with a case where a bridge electrode is provided between any respective adjacent electrodes. It is therefore possible to provide a transflective liquid crystal display device having an excellent display characteristic.

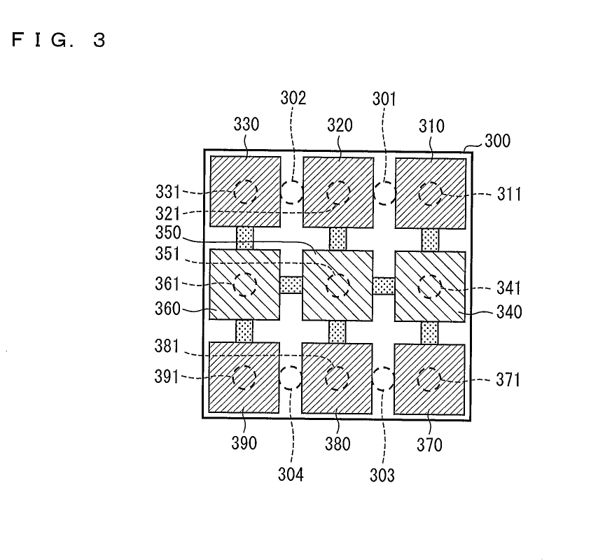

In a case where (i) a plurality of transmissive electrodes and a plurality of reflective electrodes are provided and (ii) no bridge electrode is provided between any two adjacent reflective electrodes, a distance from a feeding point where a driving voltage is supplied to a reflective electrode will be long depending on the location of the reflective electrode. In view of the circumstances, it is possible to provide a bridge electrode(s) between some reflective electrodes. This also leads to a good result from the perspective that electrical conductivity of the electrodes should be secured. In this case, it is therefore possible to reduce the adverse effect caused by the fact that a wire length etc. is lengthened within one picture element. The following description will discuss Embodiment 2 in which a plurality of reflective electrodes are provided in one picture element in detail with reference to FIG. 3.

### Embodiment 2

FIG. 3 illustrates Embodiment 2 of the present invention. In FIG. 3, a reference numeral 300 denotes one picture element. In the picture element 300, nine electrodes are provided in a matrix of three lines and three columns: namely, (i) reflective electrodes 310, 320, and 330 in a first line; (ii) transmissive electrodes 340, 350, and 360 in a second line; and (iii) reflective electrodes 370, 380, and 390 in a third line. And, (i) alignment controlling structures 311, 321, and 331 are provided in regions on a color filter side so as to face central parts of the respective reflective electrodes 310, 320, and 330, (ii) alignment controlling structures 341, 351, and 361 are provided in regions on the color filter side so as to face the central parts of the respective transmissive electrodes 340, 350, and 360, and (iii) alignment controlling structures 371, 381, and 391 are provided in regions on the color filter side so as to face the central parts of the respective reflective electrodes 370, 380, and 390.

The adjacent transmissive electrodes 340 and 350 are connected to each other via a bridge electrode, and the adjacent transmissive electrodes 350 and 360 are connected to each other via a bridge electrode. Further, as illustrated in FIG. 3, the transmissive electrodes 340, 350, and 360 are respectively connected to (i) the reflective electrodes 310, 320, and 330 via respective bridge electrodes and (ii) the reflective electrode 370, 380, and 390 via respective bridge electrodes. In this case, a picture element electrode of one picture element 300 is constituted by (i) nine electrodes in total, that is, the reflective electrodes 310, 320, and 330 and the transmissive electrodes 340, 350, and 360, and the reflective electrodes 370, 380, and 390 and (ii) the bridge electrodes each connecting a corresponding transmissive electrode to a corresponding reflective electrode or corresponding two adjacent transmissive electrodes, of the nine electrodes.

According to the present invention, any two adjacent ones of the reflective electrodes 310, 320, and 330 are not connected to each other. Similarly, any two adjacent ones of the reflective electrodes 370, 380, and 390 are not connected to each other. Further, as illustrated in FIG. 3, (i) an alignment controlling structure 301 is provided in a region, on a color filter substrate side, which region faces a region between the reflective electrode 310 and the reflective electrode 320, (ii) an alignment controlling structure 302 is provided in a region, on the color filter substrate side, which region faces a region between the reflective electrode 320 and the reflective electrode 330, (iii) an alignment controlling structure 303 is provided in a region, on the color filter substrate side, which region faces a region between the reflective electrode 370 and the reflective electrode 380, and (iv) an alignment controlling structure 304 is provided in a region, on the color filter substrate side, which region faces a region between the reflective electrode 380 and the reflective electrode 390. That is, instead of bridge electrodes for connecting adjacent reflective electrodes to each other, the alignment defining structures are provided in regions on the color filter substrate side so as to face regions between the adjacent reflective electrodes.

Note that, in Embodiment 2, (i) a picture element (sub pixel) is configured to have a shape of a square whose side is about 250 μm, (ii) each of the reflective electrodes and the transmissive electrodes having a shape of a square whose side is about 75 μm, and (iii) each of the alignment controlling structures is configured to be a circular structure with a diameter of about 17 μm. This leads to a positive outcome.

As early described, the reflective electrode has a surface on which concavities and convexities are provided for improving reflection characteristics, but this may cause an orientation state of liquid crystal molecules to be unstable. However, in accordance with the present invention, liquid crystal molecules are oriented forcibly by providing alignment controlling structures in regions, on the color filter substrate side, which face regions between the adjacent reflective electrodes. This makes an orientation state of the liquid crystal molecules stable. It is thus possible to achieve a transflective liquid crystal display device having an excellent characteristic, such as less roughness and fewer residual images.

In FIG. 3, the reflective electrodes and the transmissive electrodes are arranged in a lateral direction (leftward and rightward direction). Note, however, that these electrodes can be arranged in a vertical direction. That is, a picture element can be used which is obtained by rotating, by an angle of 90°, the picture element 300 of FIG. 3 clockwise (not specifically illustrated). In this case, a picture element electrode is constituted by nine electrodes arranged in a matrix of three lines and three columns. Of the nine electrodes, three electrodes in the second column (in the central) are transmissive electrodes, three electrodes in the first column and three electrodes in the third column are reflective electrodes. The locations of the alignment controlling structures are obtained by rotating, by an angle of 90°, the picture element 300 of FIG. 3 clockwise.

Further, in the transflective liquid crystal display device of Embodiment 2 of the present invention (see FIG. 3), reflective electrodes and transmissive electrodes which constitute one picture element electrode are increased in number as compared with the transflective liquid crystal display device of Embodiment 1 of the present invention (see FIG. 1). In regions of the increased electrodes, domains, in each of which liquid crystal molecules are tilted and orientated radially, are formed. It is thus possible to obtain a transflective liquid crystal display device of Embodiment 2 having (i) an excellent display characteristic, such as less roughness and fewer residual images, and (ii) an excellent viewing angle characteristic.

As has been described with reference to (a) and (b) of FIG. 2, which illustrate the transflective liquid crystal display device according to the variations of Embodiment 1, it is not necessary to provide alignment controlling structures in respective regions, on the color filter substrate side, which regions face “regions between the reflective electrodes”, instead of providing bridge electrodes in such regions, in order to attain an improvement in display quality of the display device, as a whole.

For example, in FIG. 3, even in a case where, instead of the alignment controlling structure 301 provided “in a region, on the color filter substrate side, which region faces a region between the reflective electrode 310 and the reflective electrode 320”, “a bridge electrode for connecting the reflective electrode 310 to the reflective electrode 320” is provided, the alignment characteristics of the display device will be significantly improved as a whole. Consequently, it is possible to provide a transflective liquid crystal display device having an excellent display characteristic, such as less roughness and fewer residual images. Further, since the transflective liquid crystal display device includes a plurality of reflective electrodes and a plurality of transmissive electrodes within one picture element, a plurality of liquid crystal domains will be formed. This brings about a further effect of having an excellent viewing angle characteristic.

That is, in a picture element electrode constituted by (i) at least one transmissive electrode, (ii) at least one pair of “two reflective electrodes which are adjacent to each other” leftward and rightward or upward and downward, and (iii) bridge electrodes each of which connects corresponding two adjacent ones of the at least one transmissive electrode and the at least one pair of reflective electrodes, no bridge electrode is provided between “two reflective electrodes which are adjacent to each other”. Instead, an alignment controlling structure is provided on a color filter substrate side so as to face that region (between the two reflective electrodes which are adjacent to each other). This allows, as a whole, an improvement in alignment characteristics of liquid crystals of the display device, as compared with a display device in which a bridge electrode are connected between any adjacent two electrodes, of the reflective electrodes and the transmissive electrodes.

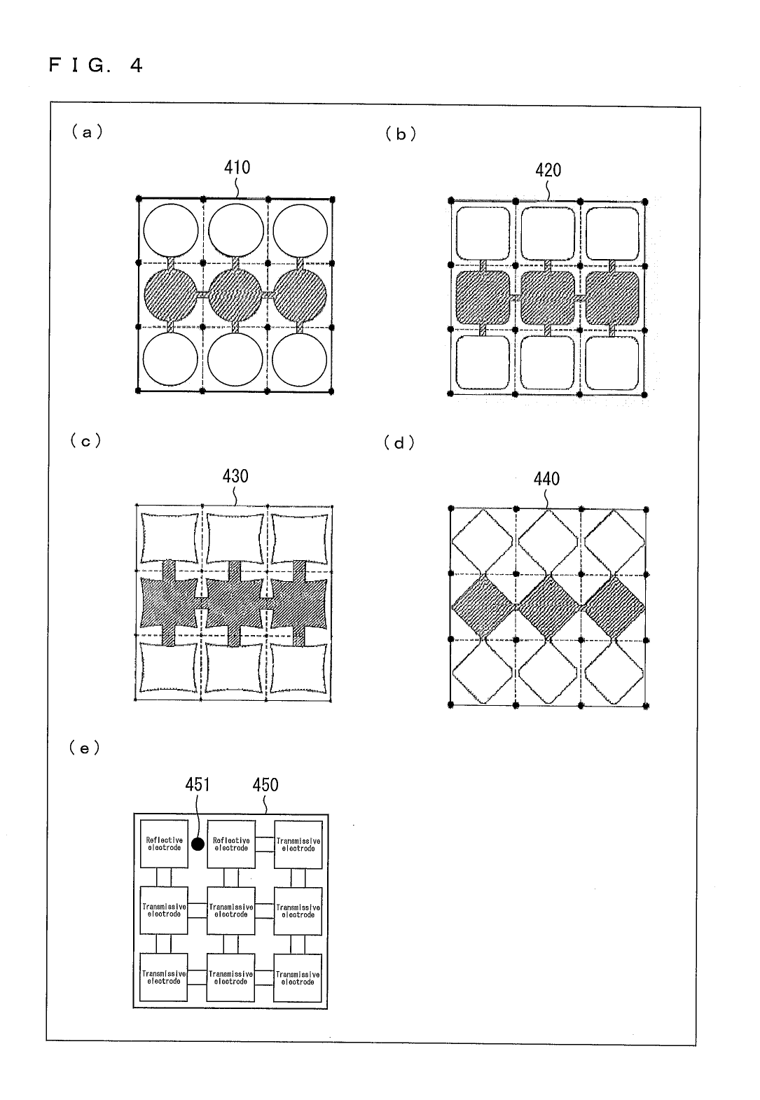

Note here that “leftward and rightward”, and “upward and downward” mean “leftward and rightward”, and “upward and downward” on a display screen of a liquid crystal display device. An example of a picture element electrode including a pair of two reflective electrodes which are adjacent to each other leftward and rightward will be described later, with reference to (e) of FIG. 4.

FIG. 4 illustrates modifications of Embodiment 2 illustrated in FIG. 3. (a) through (d) of FIG. 4 illustrate modifications in which the reflective electrodes and the transmissive electrodes illustrated in FIG. 3 are varied in shape. Note that the electrodes have the same configurations as those of FIG. 3 except for their shapes, and their detailed descriptions will be omitted. That is, in accordance with the present invention, alignment controlling structures are provided in regions, on a color filter substrate side, which face a region between reflective electrodes, and alignment controlling structures are further provided in regions, on the color filter substrate side, which substantially correspond to central parts of the respective electrodes (not illustrated in FIG. 4).

(a) of FIG. 4 illustrates a picture element 410 in which circular electrodes are provided. (b) of FIG. 4 illustrates a picture element 420 in which rectangular electrodes whose corners are rounded are provided. (c) of FIG. 4 illustrates a picture element 430 in which electrodes whose corners are prong are provided. (d) of FIG. 4 illustrates a picture element 440 in which rhomboid electrodes are provided. The electrodes which are circular or whose corners are rounded have an improved alignment stability of liquid crystals in the corners, whereas have deteriorated transmittance due to the corners which are rounded and circular. The shape of electrodes should be determined in accordance with a field in which a liquid crystal display device is used.

(e) of FIG. 4 illustrates a picture element including the different numbers of reflective electrodes and transmissive electrodes from those of (a) through (d) of FIG. 4. In (e) of FIG. 4, a display device is illustrated as an example, which includes, as picture element electrodes within one picture element, “a pair of two reflective electrodes which are adjacent to each other leftward and rightward.” Specifically, according to the example illustrated in (e) of FIG. 4, a picture element includes two reflective electrodes and eight transmissive electrodes. No bridge electrode is provided between the reflective electrodes. Instead, an alignment controlling structure 451 is provided in a region, on a color filter substrate side, which region corresponds to a region between the reflective electrodes. The liquid crystal display device is (i) designed in view of giving importance to transmittance, and (ii) suitably used as a display device for use in a field in which it is used more often indoors than outdoors. Also in this case, in accordance with the present invention, alignment controlling structures are provided in regions, on the color filter substrate side, which substantially correspond to center parts of the reflective electrodes and the transmissive electrodes (not illustrated in (e) of FIG. 4).

In each of the examples illustrated in (a) through (d) of FIG. 4, it is possible to obtain a transflective liquid crystal display device having (i) a stable orientation state of liquid crystals, and (ii) an excellent display characteristic, such as less roughness and fewer residual images. Furthermore, in the modifications illustrated in (a) through (d) of FIG. 4, the reflective electrodes are twice as many as the transmissive electrodes. It is therefore possible to provide a liquid crystal display device which is suitable for outdoor use. Since the liquid crystal display device includes a plurality of reflective electrodes and a plurality of transmissive electrodes, a plurality of domains are formed around the respective electrodes. In each of the domains, liquid crystals are tilted and oriented radially. It is therefore possible to provide a display device having an excellent viewing angle characteristic. In the modification illustrated in (e) of FIG. 4, the transmissive electrodes are more than three times as many as the reflective electrodes. The liquid crystal display device is suitable for indoor use.

The descriptions have discussed (1) a picture element including two reflective electrodes and two transmissive electrodes (Embodiment 1), (2) a picture element including three reflective electrodes and one transmissive electrode (a modification of Embodiment 1), (3) a picture element including three reflective electrodes and six transmissive electrodes (Embodiment 2), and (4) a picture element including two reflective electrodes and seven transmissive electrodes (a modification of Embodiment 2). Note, however, that the present invention is not limited to the picture elements (1) through (4). The present invention is therefore applicable to, for example, (i) a picture element including three reflective electrodes and three transmissive electrodes or (ii) a picture element including more than three reflective electrodes and more than three transmissive electrodes. In FIG. 3, and (a) through (d) of FIG. 4, the reflective electrodes and the transmissive electrodes are arranged in lateral directions of the drawings. Note, however, that the directions are not limited to the lateral direction, and therefore the reflective electrodes and the transmissive electrodes can be arranged in vertical directions.

Further, according to the present invention, the alignment controlling structures are provided only on the color filter side, and no protrusion or the like is provided on an active matrix substrate side. This brings about an effect of simplifying the manufacturing process.

### Summary of Embodiments

As described above, in order to attain the object, a further transflective liquid crystal display device in accordance with the present invention is characterized in that each of the picture element electrodes is constituted by two reflective electrodes and two transmissive electrodes.

According to the configuration, a transflective liquid crystal display device having (i) a high level of visibility in both indoor and outdoor environments, (ii) a stable orientation state, and (iii) an excellent characteristics, such as less roughness and fewer residual images. Since two reflective electrodes and two transmissive electrodes are provided in one picture element, a plurality of liquid crystal domains will be generated. This brings about an effect of having an excellent viewing angle characteristic. Further, since one picture element includes the same numbers of the reflective electrodes and the transmissive electrodes, it is possible to achieve a transflective liquid crystal display device having relatively high definition.

In order to attain the object, a further transflective liquid crystal display device in accordance with the present invention is characterized in that each of the picture element electrodes is constituted by nine electrodes arranged in a matrix of three lines and three columns, and three electrodes in a second line of the matrix are transmissive electrodes, and three electrodes in a first line and three electrodes in a third line are reflective electrodes.

According to the configuration, the reflective electrodes which are twice as many as the transmissive electrodes are provided. This makes it possible to achieve a liquid crystal display device suitable for use as a display device of a mobile device or the like which is often used outdoors, the liquid crystal display device having (i) a stable orientation state of liquid crystals, and (ii) an excellent display characteristic, such as less roughness and fewer residual images. According to the configuration, the numbers of the reflective electrodes and the transmissive electrodes constituting one picture element are increased. Domains, in each of which liquid crystals are tilted and oriented radially, are formed around the respective electrodes. This makes it possible to achieve a transflective liquid crystal display device having (i) a stable orientation state, (ii) an excellent display characteristic, such as less roughness and fewer residual images, and (iii) an excellent viewing angle characteristic.

In order to attain the object, a further transflective liquid crystal display device in accordance with the present invention is characterized in that each of the picture element electrodes is constituted by nine electrodes arranged in a matrix of three lines and three columns, and three electrodes in a second column of the matrix are transmissive electrodes; and three electrodes in a first columns and three electrodes in a third column are reflective electrodes.

According to the configuration, as with the above-described case, the reflective electrodes which are twice as many as the transmissive electrodes are provided. This makes it possible to achieve a liquid crystal display device suitable for use as a display device of a mobile device or the like which is often used outdoors, the liquid crystal display device having (i) a stable orientation state of liquid crystals, and (ii) an excellent display characteristic, such as less roughness and fewer residual images. According to the configuration, the numbers of the reflective electrodes and the transmissive electrodes constituting one picture element are increased. Domains, in each of which liquid crystals are tilted and oriented radially, are formed around the respective electrodes. This makes it possible to achieve a transflective liquid crystal display device having (i) a stable orientation state, (ii) an excellent display characteristic, such as less roughness and fewer residual images, and (iii) an excellent viewing angle characteristic.

In order to attain the object, a further transflective liquid crystal display device in accordance with the present invention is characterized in that each of the reflective electrodes and the transmissive electrodes, which constitute the picture element electrode, is rectangular. Alternatively, in order to attain the object, a further transflective liquid crystal display device in accordance with the present invention is characterized in that each of the reflective electrodes and the transmissive electrodes, which constitute the picture element electrode, is circular. Alternatively, in order to attain the object, a further transflective liquid crystal display device in accordance with the present invention is characterized in that each of the reflective electrodes and the transmissive electrodes, which constitute the picture element electrode, is rhomboid.

According to the electrodes having the above described shapes, it is also possible to provide a transflective liquid crystal display device having a stable orientation state and an excellent viewing angle characteristic. Further, in a case where the electrode is circular or has corner sections which are circular, it is possible to achieve further improvement in alignment stability.

The specific embodiments or examples described in the Detailed Description of the present invention are to clarify the technical contents of the present invention. The present invention is not limited to the embodiments and should not be interpreted in a narrower sense, and can therefore be modified in many ways within the spirit of the present invention and the scope of Claims thereof.

### INDUSTRIAL APPLICABILITY

According to the present invention, it is possible to provide a transflective liquid crystal display device suitable for use in a mobile device or the like which is often used indoors and outdoors, the transflective liquid crystal display device having an excellent display characteristic, such as less roughness and fewer residual images. Therefore, the present invention has notable industrial applicability.

### REFERENCE SIGNS LIST

100 Picture element
110, 120 Reflective electrode
130, 140 Transmissive electrode
111, 121, 131, 141, 151 Alignment controlling structure
112, 122, 132, 142, 152 Orientation axis center
113, 123, 133, 143 Alignment direction
155, 156, 157 Bridge electrode
162 Color filter substrate
163 Counter electrode
200 Picture element
210 Transmissive electrode
220, 230, 240 Reflective electrode
251, 252, 253, 254 Bridge electrode
261, 262 Alignment controlling structure
300 Picture element
310, 320, 330, 370, 380, 390 Reflective electrode
340, 350, 360 Transmissive electrode
311, 321, 331, 341, 351, 361, 371, 381, 391 Alignment controlling structure
410, 420, 430, 440, 450 Picture element
451 Alignment controlling structure

1. A transflective liquid crystal display device comprising:
a first substrate on which a plurality of picture element electrodes and driving elements for selectively driving the picture element electrodes are provided; and
a second substrate on which color filters are formed; and
liquid crystals sealed between the first substrate and the second substrate,
each of the plurality of picture element electrodes being constituted by (i) at least one transmissive electrode, (ii) at least one pair of two reflective electrodes which are adjacent to each other leftward and rightward or upward and downward, and (iii) bridge electrodes via each of which two adjacent ones of the at least one pair of reflective electrodes and the at least one transmissive electrode are connected to each other,
the at least one pair of two reflective electrodes which are adjacent to each other being not connected to each other via the bridge electrode,
alignment controlling structures for controlling alignment of the liquid crystals being provided in regions, on a second substrate side, which face respective central parts of the at least one pair of reflective electrodes and the at least one transmissive electrode,
an alignment controlling structure(s) for controlling alignment of the liquid crystals being further provided in a region, on the second substrate side, which region faces a region, where no bridge electrode is provided, between the at least one pair of two reflective electrodes which are adjacent to each other.

2. The transflective liquid crystal display device as set forth in claim 1, wherein:
each of the picture element electrodes is constituted by two reflective electrodes and two transmissive electrodes.

3. The transflective liquid crystal display device as set forth in claim 1, wherein:
each of the picture element electrodes is constituted by nine electrodes arranged in a matrix of three lines and three columns, and
three electrodes in a second line of the matrix are transmissive electrodes, and three electrodes in a first line and three electrodes in a third line are reflective electrodes.

4. The transflective liquid crystal display device as set forth in claim 1, wherein:
each of the picture element electrodes is constituted by nine electrodes arranged in a matrix of three lines and three columns, and
three electrodes in a second column of the matrix are transmissive electrodes; and three electrodes in a first columns and three electrodes in a third column are reflective electrodes.

5. The transflective liquid crystal display device as set forth in claim 1, wherein:
each of the reflective electrodes and the transmissive electrodes, which constitute the picture element electrode, is rectangular.

6. The transflective liquid crystal display device as set forth in claim 1, wherein:
each of the reflective electrodes and the transmissive electrodes, which constitute the picture element electrode, is circular.

7. The transflective liquid crystal display device as set forth in claim 1, wherein:
each of the reflective electrodes and the transmissive electrodes, which constitute the picture element electrode, is rhomboid.
